(19) United States
(12) Patent Application Publication
(10) Pub. No.: US 2006/0177027 A1
(43) Pub. Date: Aug. 10, 2006

(54) "Fone Fun" Word Game Apparatus and Method

(76) Inventor: Joseph L. Congdon, Niskayuna, NY (US)

Correspondence Address: LAW OFFICE OF JAY R. YABLON, 910 NORTHUMBERLAND DRIVE, SCHENECTADY, NY, 12309-2814, US

(21) Appl. No.: 11/308,344

(22) Filed: Mar. 17, 2006

(51) Int. Cl. H04M 11/00

(52) U.S. Cl. 379/93.18

(57) ABSTRACT

A word game device and method is disclosed wherein the user is provided: a numeric clue comprising a sequence of numeric digits; a word hint comprising a single word or a sequence of words; and a word answer corresponding with said numeric clue when decrypted using a telephone keypad alphanumeric correspondence as a decryption key, and bearing a conceptual relation to said word hint.

### FILED OF THE INVENTION

This invention is in the field of word games, and relates specifically to a puzzle game using the digits of a telephone keypad to represent words and phrases guessed by the game user.

### BACKGROUND OF THE INVENTION

Word games are very popular in the United States and throughout the world. Perhaps the most popular such word game is the crossword puzzle where the puzzle user is given a clue to a word or phrase, and then tries to guess at the word or phrase by considering the number of letters allotted in the puzzle as well as letters already placed due to crossing words.

The keypad of a telephone contains a familiar cross-referencing of letters and numbers. This well-known correspondence of one digit to three or four letters, is 2=A,B,C; 3=D,E,F; 4=G,H,I; 5=J,K,L; 6=M,N,O; 7=P,Q,R,S; 8=T,U,V; 9=W,X,Y,Z.

Because most Americans carry a phone with them or use phones regularly and are very familiar with the keypad layout of a phone, it would be desirable to have a word-guessing game based on this correspondence of letters to numbers on a telephone keypad.

### SUMMARY OF THE INVENTION

A word game device and method is disclosed wherein the user is provided: a numeric clue comprising a sequence of numeric digits; a word hint comprising a single word or a sequence of words; and a word answer corresponding with said numeric clue when decrypted using a telephone keypad alphanumeric correspondence as a decryption key, and bearing a conceptual relation to said word hint.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) and appendices summarized below.

FIG. 1 illustrates a first exemplary puzzle in accordance with the invention.

FIG. 2 illustrates a second exemplary puzzle in accordance with the invention.

FIG. 3 illustrates a number of numeric clues, word hints, and word answers which may be used—for example only—in connection with the invention.

FIG. 4 illustrates additional numeric clues, word hints, and word answers which may be used—for example only—in connection with the invention.

### DETAILED DESCRIPTION

The invention disclosed herein makes use of the standard telephone keypad correspondence between letters and numbers, namely, 2=A,B,C; 3=D,E,F; 4=G,H,I; 5=J,K,L; 6=M,N,O; 7=P,Q,R,S; 8=T,U,V; 9=W,X,Y,Z, as the basis for a word guessing game. In this disclosure, we shall refer to this as the “telephone keypad alphanumeric correspondence.” The user is provided a sequence of numbers, and a word clue. Based on the numbers provided and the word hint, and using the telephone keypad alphanumeric correspondence as a “decryption key,” the user guesses at the answer.

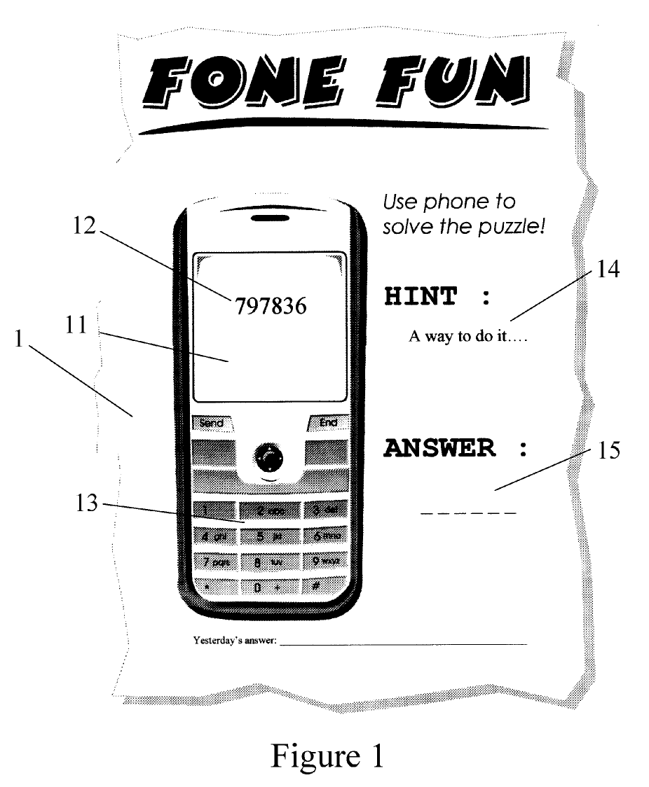

FIG. 1 illustrates a possible embodiment of the invention, with an exemplary puzzle. A telephone handset 1 is illustrated, and on the handset display 11, a numeric clue 12 comprising a sequence of numeric digits is represented in a form perceptible to a user of the game (e.g., visual, auditory, tactile). In this particular example, numeric clue 12 is “797836,” and the perceptible form is visual. Using the telephone keypad alphanumeric correspondence 13, the user then maps out the possible words that can be constructed from the given numeric sequence, namely: (7=P,Q,R,S) (9=W,X,Y,Z) (7=P,Q,R,S) (8=T,U,V) (3=D,E,F) (6=M,N,O). A word hint 14 is also represented in a form perceptible to the user. In this example, the word hint 14 is “a way to do it . . . ” and the perceptible form is also visual. The user ponders the possibilities, and, if astute, will arrive at the word answer 15 (which may be a single word or a plurality of words), which for this example, is “system.” It is to be observed that this particular word answer 15 “system” is within the possible range of words which can be constructed via the telephone keypad alphanumeric correspondence from the given numeric sequence, and that the word answer 15 bears a conceptual relation to the word hint 14. Of course, the word answer 15 should also be available to the user, in a form perceptible to the user, but in such a manner that the user can perceive the numeric clue 12 and word hint 14 separately from perceiving the word answer 15. Otherwise, were the answer to be provided right together with the puzzle itself, the whole purpose of guessing at the puzzle would be defeated.

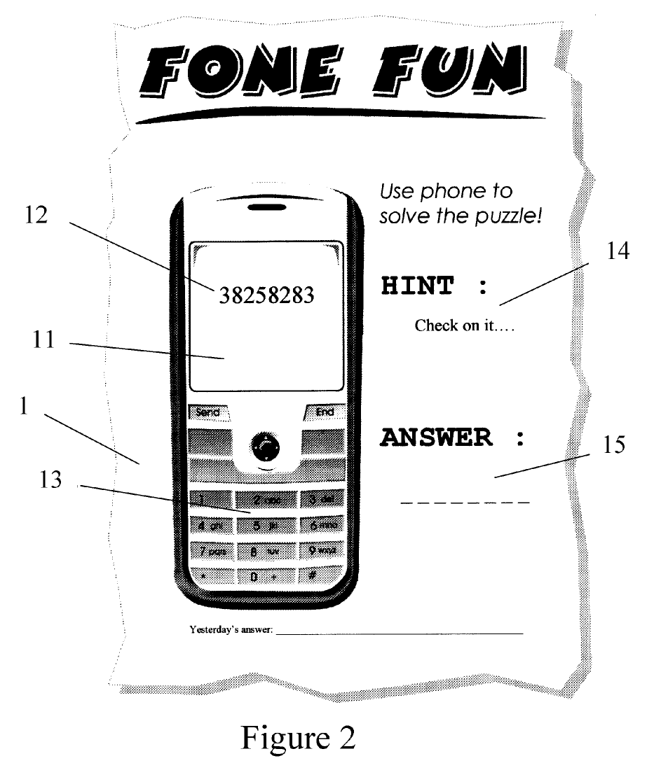

FIG. 2 illustrates a second exemplary puzzle. Here, the numeric clue 12 is 38258283, and the word hint 14 is “Check on it . . . ” The word answer 15 is “evaluate,” and once again, is among the range of letter combinations which can be constructed via the alphanumeric correspondence 13.

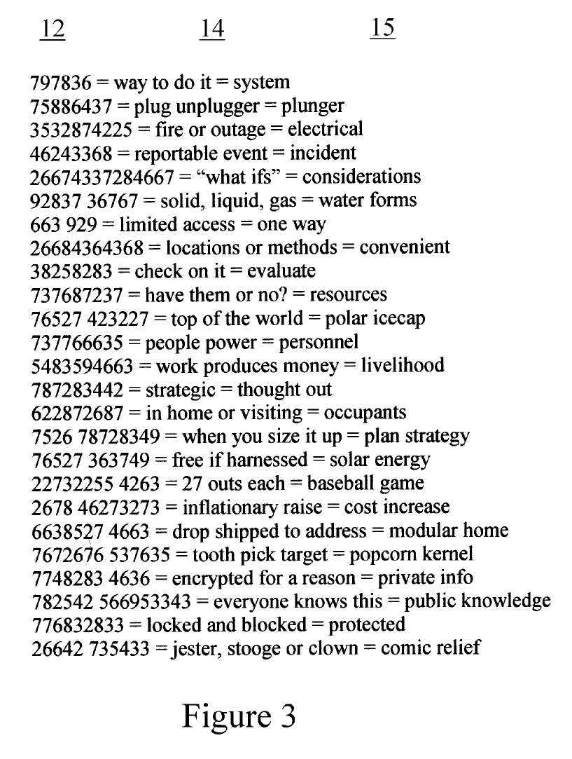

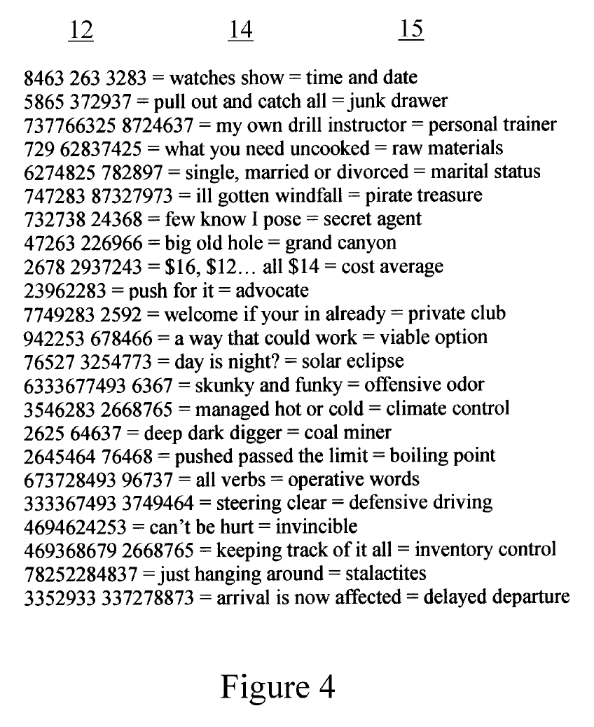

FIG. 3 shows a large number of numeric clues 12, word hints 14, and word answers 15, including the two just described. For example, 76527 423227 is a two-word numeric clue 12, the word hint 14 is “top of the world . . . ” and the word answer 15 is the plurality of words “polar icecap” which is derived from the telephone keypad alphanumeric correspondence to 76527 423227. The space between the 76527 and the 423227 is what tells the user that this answer has two words, but of course other ways of indicating separate words is considered to be within the scope of this disclosure and its associated claims. FIG. 4 shows some further numeric clues 12, word hints 14, and word answers 15. These are all for example only, and in no way intended to be limiting. It should be understood that it is possible to come up with a virtually-limitless variety of numeric clues 12, word hints 14, and word answers 15, all within the scope of this disclosure and its associated claims.

The invention as described above can be embodied in many ways. For example, one embodiment of the invention is in the form of printed matter visually perceptible to the user, for example, in a book or newspaper or magazine. A newspaper or magazine or other similar printed matter contains a puzzle depiction similar to that shown in FIGS. 1 and 2, where a numeric clue 12 is provided along with a word hint 14. The user then guesses the word answer 15. As is done with crossword and other puzzles, the answer 15 is printed, for example, in the next edition of the newspaper or magazine. Or, for a book, there may be an answer key at the back of the book, or upside down at the bottom the page. Again, to avoid defeating the purpose of the puzzle, the word answer 15 is made available to the user, but in a manner such that the user can perceive the numeric clue 12 and word hint 14 separately from perceiving the word answer 15.

Another embodiment of the invention is electronic. A user may purchase computer software, such as on a disk, where a numeric clue 12 is shown, the user is given a word hint 14, and then the user guesses at the word answer 15. Alternatively, this game may be hosted on a web page, wherein the user accesses the game, for example, on a web page over a telecommunications network such as the internet, and again is provided a numeric clue 12 and a word hint 14, thereafter guessing at the word answer 15.

Another embodiment of the invention—also electronic—is a telephone device itself. The game may be one of the options available on a real cellular or other telephone. The display window 11 of the telephone displays the numeric clue 12 as well as the word hint 14, and the user then guesses at the word answer 15. It is understood that a “toy” telephone, which cannot actually communicate, may also be used as a game embodiment. This might be enjoyed, for example, by a youngster who is too young to have his or her own “real” phone, but who might nevertheless find challenge and learning in the game itself. Various versions of the game may be developed for various skill levels, ranging from novice through expert. For expert levels, the word hints 14 as well as the numeric clues 12 may be made more difficult.

Another embodiment of the invention is in the form of, for example, a board game or a card game. The user picks a card with a numeric clue 12 and a word hint 14. The word answer 15 may be provided, for example, on the back of the card. This game as disclosed herein may also be combined with a time elements, so that the person who solves the puzzle first in competition against others, or within a limited period of time in competition with a clock, for example, is declared a “winner.”

Another embodiment of the invention is audible. For example, the invention might be embodied in a radio station call-in show, where a sequence of digits comprising numeric clue 12 is recited to listeners together with a word hint 14. Listeners to the broadcast then have an opportunity to call in a guess at the word answer 15. The caller with the correct answer may then win some form of prize.

Another embodiment of the invention would be in the form of a televised game show, where contestants are given numeric clues 12 and word hints 14 and compete against time or against one another to find the word answer 15.

Another embodiment of the invention is in connection with promotional literature or product packaging. For example, not limitation, a milk carton or a cereal box may have the numeric clue 12 and word hint 14 printed on its outside, so that a person consuming the product can also try to solve the puzzle. The word answer 15 might, for example, not limitation, be provided on the inside of the container, so that the user can only see the word answer 15 when the container is emptied of its product.

It is also understood that the telephone keypad upon which this invention rests is the English language keypad. But, the use of keypads from other languages with different alphabets, as the decryption key, is also considered within the scope of this disclosure and it associated claims.

All of the above are just examples of ways in which this game might be embodied, and are not intended in any way to be limiting.

While the presentation of the numeric clue 12 and word hint 14 was illustrated in FIGS. 1 and 2 to be visually perceptible to a user of the game, that is also not limiting. For example, the numeric clue 12 and word hint 14 might be presented in Braille, which is discernable by tactile means to someone who is visually impaired. Numeric clue 12 and word hint 14 might also be presented audibly, wherein the numeric sequence and clue can be heard by the user. This may be, as discussed, in connection with a radio show, or might be in some form of audible recording on recording tapes or computer memory devices such as employed in electronics devices such as the presently-popular I-pod type audio device.

While only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

What is claimed is:

1. A word game apparatus, comprising:
a numeric clue comprising a sequence of numeric digits, represented in a form perceptible to a user of said apparatus;
a word hint comprising a single word or a sequence of words, also represented in a form perceptible to the user; and
a word answer corresponding with said numeric clue when decrypted using a telephone keypad alphanumeric correspondence as a decryption key, and bearing a conceptual relation to said word hint, also represented in a form perceptible to the user.

2. The apparatus of [claim 1], wherein the user can perceive said numeric clue and said word hint separately from perceiving said word answer.

3. The apparatus of [claim 1], wherein said numeric clue and said word hint are represented to the user on visually-perceptible printed matter.

4. The apparatus of [claim 3], said visually-perceptible printed matter comprising a newspaper or magazine page.

5. The apparatus of [claim 1], wherein said numeric clue and said word hint are represented to the user in a manner that can be perceived by the user's auditory senses.

6. The apparatus of [claim 5], wherein said numeric clue and said word hint are represented to the user's auditory senses via a radio broadcast.

7. The apparatus of [claim 1], wherein said numeric clue and said word hint are represented to the user in a manner that can be perceived by the user's tactile senses.

8. The apparatus of [claim 1], wherein said numeric clue and said word hint are represented to the user using an electronic device.

9. The apparatus of [claim 8], said electronic device comprising a telephone.

10. The apparatus of [claim 1], wherein said numeric clue and said word hint are represented to the user over an telecommunications connection.

11. The apparatus of [claim 1], wherein the user is a contestant on a television game show, and said numeric clue and said word hint are represented to the user as part of said game show.

12. The apparatus of [claim 1], wherein said numeric clue and said word hint are represented to the user as part of a game where said user competes against time or against other users.

13. A word game method, comprising:
providing a numeric clue comprising a sequence of numeric digits, represented in a form perceptible to a user of said apparatus;
providing a word hint comprising a single word or a sequence of words, also represented in a form perceptible to the user;
providing a word answer corresponding with said numeric clue when decrypted using a telephone keypad alphanumeric correspondence as a decryption key, and bearing a conceptual relation to said word hint, also represented in a form perceptible to the user.

14. The method of claim [claim 13], wherein the user can perceive said numeric clue and said word hint separately from perceiving said word answer.

15. The method of [claim 13], further comprising representing said numeric clue and said word hint to the user using visually-perceptible printed matter.

16. The method of [claim 15], further comprising representing said visually-perceptible printed matter to the user using a newspaper or magazine page.

17. The method of [claim 13], further comprising representing said numeric clue and said word hint to the user in a manner that can be perceived by the user's auditory senses.

18. The method of [claim 17], further comprising representing said numeric clue and said word hint to the user's auditory senses via a radio broadcast.

19. The method of [claim 13], further comprising representing said numeric clue and said word hint to the user in a manner that can be perceived by the user's tactile senses.

20. The method of [claim 13], further comprising representing said numeric clue and said word hint to the user using an electronic device.

21. The method of [claim 20], said electronic device comprising a telephone.

22. The method of [claim 13], further comprising representing said numeric clue and said word hint to the user over an telecommunications connection.

23. The apparatus of [claim 13], further comprising representing said numeric clue and said word hint to said user who is a contestant on a television game show.

24. The apparatus of [claim 13], further comprising representing said numeric clue and said word hint are represented to the user as part of a game, wherein said user competes against time or against other users.
